(19) United States
(12) Patent Application Publication
(10) Pub. No.: US 2025/0353332 A1
(43) Pub. Date: Nov. 20, 2025

(54) TIRE COMPRISING A CORRUGATED CROWN LAYER AND A SIDEWALL STIFFENING INSERT

(71) Applicant: COMPAGNIE GENERALE DES ETABLISSEMENTS MICHELIN, Clermont-Ferrand (FR)

(72) Inventors: FRANCOIS-XAVIER BRUNEAU, Clermont-Ferrand (FR); BENJAMIN VILPERT, Clermont-Ferrand (FR); JOHN CHURCH, Clermont-Ferrand (FR); PATRICE FRAYSSE, Clermont-Ferrand (FR); FRANCOIS CHAMBRIARD, Clermont-Ferrand (FR)

(21) Appl. No.: 18/854,890

(22) PCT Filed: Mar. 6, 2023
(86) PCT No.: PCT/EP2023/055614

§ 371 Date: Oct. 7, 2024

(30) Foreign Application Priority Data
Apr. 8, 2022 (FR) FR2203231

(51) Int. Cl. B60C 17/00; B60C 9/18; B60C 9/28

(52) U.S. Cl. CPC B60C 17/0009; B60C 9/28; B60C 2009/1828; B60C 2017/0063; B60C 2017/0072

(57) ABSTRACT

A tire (10) not suitable for running flat comprises a crown block (12), two beads (32), and two sidewalls (30) connecting each bead (32) to the crown block (12). The crown block (12) comprises a crown reinforcement (16) comprising a corrugated crown layer (24, 26, 28) comprising corrugations. The sidewall (30) comprises a sidewall insert (90) comprising an elastomeric composition (92) referred to as a rigid elastomeric composition having a modulus at 10% extension greater than or equal to 6 MPa and a maximum thickness (Emax) less than or equal to 5.0 mm.

The present invention relates to a tyre. The term “tyre” should be understood to mean a tyre casing intended to form a cavity by cooperating with a support element, for example a rim, this cavity being capable of being pressurized to a pressure greater than atmospheric pressure. A tyre according to the invention has a structure of substantially toroidal shape exhibiting symmetry of revolution about a main axis of the tyre.

A tyre comprising a crown block, two beads and two sidewalls connecting each bead to the crown block is known from EP3529087. The crown block comprises a tread and a crown reinforcement arranged radially to the inside of the tread. The crown reinforcement comprises a working reinforcement comprising two working layers and a hoop reinforcement comprising a hooping layer, the hoop reinforcement being arranged radially to the outside of the working reinforcement. Each working layer and hooping layer comprises several corrugations. Each corrugation of each crown layer comprises a top and first and second bottoms adjacent to said top arranged in such a way that said top is arranged axially between said first and second bottoms and such that said top is arranged radially to the outside of each first and second bottom. Due to the presence of the corrugations, each layer of the crown reinforcement that has at least one corrugation is referred to as a corrugated crown layer.

Because of the corrugated crown layers, such a tyre has a crown block that has very high lateral rigidity, vertical rigidity and cornering rigidity, in any event much higher than those of a similar tyre comprising substantially cylindrical crown layers without corrugations.

Despite these high levels of rigidity, it has surprisingly been observed that vehicles equipped with such tyres do not behave at the level expected with corrugated crown layers, even though this level of behaviour is nevertheless better than the level of behaviour of a tyre not provided with a corrugated crown layer.

The aim of the invention is to improve the behaviour of vehicles equipped with tyres comprising at least one corrugated crown layer.

To this end, the invention relates to a tyre not suitable for running flat comprising a crown block, two beads, two sidewalls connecting each bead to the crown block, the crown block comprising a tread and a crown reinforcement arranged radially to the inside of the tread, the crown reinforcement comprising a central part with an axial width equal to 80% of the axial width of the crown reinforcement and axially centred on the median plane of the tyre, the crown reinforcement comprising at least one crown layer, referred to as a corrugated crown layer, comprising reinforcing elements embedded in a polymeric matrix, said corrugated crown layer comprising, in the central part of the crown reinforcement, at least one corrugation, the or each corrugation of said corrugated crown layer comprising a top of said corrugated crown layer and first and second bottoms of said corrugated crown layer adjacent to said top arranged in such a way that:
said top is arranged axially between said first and second bottoms,
said top is arranged radially to the outside of each first and second bottom, the tyre comprising a sidewall insert arranged axially between an outer surface of at least one of the sidewalls and an inner surface of said sidewall, the sidewall insert comprising at least one elastomeric composition referred to as a rigid elastomeric composition, the or each rigid elastomeric composition of the sidewall insert having a modulus at 10% extension greater than or equal to 6 MPa, the maximum thickness of the rigid elastomeric composition or the assembly of rigid elastomeric compositions being less than or equal to 5.0 mm.

In order to produce the invention, the inventors needed to understand why the behaviour achieved was not at the expected level. After many tests, the inventors determined that the sidewalls of the tyre form a flexible portion lying between two rigid portions formed by the crown reinforcement and by each bead.

Indeed, on the one hand, due to its function as an interface with the support on which the tyre is mounted, for example a rim, each bead is rigid, in particular as a result of the materials from which it is made and its considerable thickness. These materials include, in particular, reinforcing elements, which are generally metal or indeed elastomeric compositions with high levels of rigidity, for example moduli at 10% extension greater than 20 MPa.

On the other hand, since the crown reinforcement has at least one corrugated crown layer, the crown reinforcement is also relatively rigid, and certainly more rigid than a crown reinforcement that has no corrugated crown layer.

Therefore, when a major load is applied to the tyre, the rigid portions formed by the crown reinforcement and the beads transmit a relatively high proportion of this load to the less rigid part of the tyre, in this case each sidewall. However, as each sidewall is arranged radially between each bead and the crown block comprising the crown reinforcement, each sidewall bends with a relatively large amplitude, which explains why the behaviour is not at the expected level.

Once they had understood the reason for the behaviour, the inventors who produced the invention also needed to find the technical solution that would offer the best performance compromise.

The inventors therefore discovered that using a sidewall insert with a relatively high level of rigidity, in any case higher than the rigidity of the elastomeric compositions that are conventionally used in tyre sidewalls, helped reduce the amplitude of the bending of each sidewall when a significant load was applied to the tyre. This improved the behaviour of the vehicle.

Moreover, using a sidewall insert according to the invention has the advantage of providing a better compromise between its manufacturing cost and its behaviour, unlike other solutions such as, for example, the use of a reinforced carcass reinforcement. Indeed, since the sidewall insert at least partially replaces a material that was already used in the sidewall of the tyre, the manufacturing cost of the tyre according to the invention is not increased significantly compared to a tyre that does not have the sidewall insert.

The modulus at 10% extension, which is commonly referred to as MA10, is the elastic modulus of the mixture measured during uniaxial tensile testing, at an elongation value of 0.1 (i.e., 10% elongation, expressed as a percentage). The uniaxial tension is applied to the test specimen at a constant rate, and the elongation and the force are measured. The measurements are taken using a tensile tester of the INSTRON (registered trademark) type, at a temperature of 23° C., and a relative humidity of 50% (ISO 23529 standard). The conditions for measuring and using the results in order to determine the elongation and the stress are as described in the NF ISO 37:2012-03 standard. The stress is determined for an elongation of 0.1 and the modulus of elasticity under tension at 10% elongation is calculated as the ratio of this stress value to the elongation value. A person skilled in the art will know how to select and adapt the dimensions of the test specimen according to the quantity of mixture that is accessible and available, in particular in the event that test specimens are taken from the tyre.

The elastomeric composition of the sidewall insert is made from one or several elastomer(s). It may also comprise fillers and other components routinely used in the field of compositions for tyres.

The tyre according to the invention is not a tyre suitable for running flat. A tyre suitable for running flat is suitable for running when the pressure of the internal cavity of the tyre is equal to atmospheric pressure (through improper use of language, it is often said that the pressure is zero, whereas it is the overpressure with respect to atmospheric pressure that is zero). A tyre suitable for running flat comprises self-supporting sidewalls, i.e., sidewalls that are capable, when at a pressure equal to atmospheric pressure, of bearing the same load, for example the rated load as indicated in the European Tyre and Rim Technical Organisation (ETRTO) Standards Manual 2021, as the tyre is capable of bearing when inflated to its usual inflation pressure, for example its nominal inflation pressure as indicated in the ETRTO Standards Manual 2021, over a distance greater than or equal to a certain threshold at a speed greater than or equal to 80 km/h. Thus, a tyre suitable for running flat is such that, under its rated load as indicated in the ETRTO Standards Manual 2021 and under atmospheric pressure, the or each sidewall cannot bend on itself in such a way as to bring two portions of the tyre that are set apart from each other into contact with one another. Conversely, a tyre that is not suitable for running flat is such that, under its rated load as indicated in the ETRTO Standards Manual 2021 and under atmospheric pressure, the or each sidewall bends on itself in such a way as to bring two portions of the tyre that are set apart from each other into contact with one another.

A tyre suitable for running flat preferably has a specific marking indicating the ability of the tyre to run flat. Thus, for example, markings in the form of the following acronyms are used, without this list being exhaustive: “ZP” for “Zero Pressure”, “SST” for “Self Supporting Technology”, “SSR” for “Self Supporting Runflat Tyre”, “RF” for “Run Flat”, “RFT” for “Run Flat Tyre”, “EXT” for “EXTended”, “ZP-SR” for “Zero Pressure Short Range” or indeed “ZPS” for “Zero Pressure System”. Another specific marking indicating the ability of the tyre to run flat is the presence of the letter “F” in the tyre dimension number. Thus, tyres with dimensions 225/40R18 or 225/40ZR18 are marked 225/40RF18 or 225/40ZRF18, if they are suitable for running flat.

The maximum thickness of the rigid elastomeric composition or of the assembly of rigid elastomeric compositions is the maximum value of the thicknesses of the rigid elastomeric composition or of the assembly of rigid elastomeric compositions, the thickness being able to be constant or variable. A thickness of the rigid elastomeric composition or of the assembly of rigid elastomeric compositions is defined, in a meridian section plane, as the thickness of the rigid elastomeric composition or of the assembly of rigid elastomeric compositions at a point of the inner surface of the tyre. The thickness of the rigid elastomeric composition or of the assembly of rigid elastomeric compositions at this point of the inner surface is the straight distance along the normal to the inner surface at said point of the inner surface between the radially innermost point of the rigid elastomeric composition or of the assembly of rigid elastomeric compositions and the radially outermost point of the rigid elastomeric composition or of the assembly of rigid elastomeric compositions, these points of the sidewall inserts being aligned along the normal with said point of the inner surface.

The inner surface delimits the internal cavity of the tyre. The internal cavity is intended to be pressurized with inflation gas once the tyre is mounted on a mounting support, for example a rim. The inner surface of the sidewall is therefore the part of the sidewall delimiting the internal cavity of the tyre.

The outer surface is the surface of the tyre in contact with air at atmospheric pressure and visible from the outside of the tyre. The outer surface of the sidewall is therefore the part of the sidewall in contact with air at atmospheric pressure and visible from the outside of the tyre.

In a preferred embodiment, the or each sidewall insert comprises a rigid elastomeric composition. In certain variants, the or each sidewall insert is constituted by a rigid elastomeric composition. In other variants, the or each sidewall insert comprises a rigid elastomeric composition and one or more elastomeric composition(s) referred to as flexible elastomeric composition(s), the modulus of which at 10% extension is strictly less than 6 MPa. In these embodiments, the maximum thickness is the thickness of the rigid elastomeric composition.

However, in other embodiments, it may be envisaged that the or each sidewall insert comprises several rigid elastomeric compositions. In these embodiments, the maximum thickness is the maximum thickness of the assembly of rigid elastomeric compositions, i.e., the maximum value of the sum of the thicknesses of each rigid elastomeric composition measured along the same normal to the inner surface of the tyre. In certain variants of these embodiments comprising several rigid elastomeric compositions, all of the elastomeric compositions of the sidewall insert are rigid elastomeric compositions. In other variants of these embodiments comprising several rigid elastomeric compositions, the sidewall insert comprises, in addition to the rigid elastomeric compositions, one or more elastomeric composition(s) referred to as flexible elastomeric composition(s), the modulus of which at 10% extension is strictly less than 6 MPa. In these other variants, the maximum thickness does not take into account the thickness of the or each flexible elastomeric composition, the maximum thickness being defined as the maximum thickness of the assembly of rigid elastomeric compositions.

The expression “bottoms adjacent to a top” should be understood to mean that no other bottom is arranged axially between the top and each adjacent bottom.

Unless the or each corrugated crown layer describes a polygonal line comprising straight segments in each meridian section plane, each corrugation comprises two inflection points arranged axially between the top and each first and second bottom. The expression “inflection point” should be understood to mean a point at which, in a meridian section plane, the direction of the curvature of the or each corrugated crown layer changes.

The axial width of the crown reinforcement is the width in the axial direction of the layer of the crown reinforcement having the largest width in the axial direction. The width in the axial direction is the distance in the axial direction between the two axial ends of a layer. The or each layer of the crown reinforcement may be axially continuous or axially discontinuous between its two axial ends. The crown reinforcement of a tyre for a passenger vehicle conventionally comprises a hoop reinforcement and a working reinforcement arranged radially to the inside of the hoop reinforcement, the hoop reinforcement being arranged radially between the tread and the working reinforcement, the hoop reinforcement comprising at least one hooping layer and the working reinforcement comprising at least one working layer.

The central part being axially centred on the median plane of the tyre means that each axial end of the central part is situated at an axial distance from the median plane of the tyre equal to 40% of the axial width of the crown reinforcement.

The expression “reinforcing element” should be understood to mean an element that helps to mechanically reinforce the polymeric matrix in which this reinforcing element is intended to be embedded.

Preferably, each reinforcing element is filamentary, i.e., the length of each reinforcing element is at least 10 times greater than the largest dimension of its cross section, irrespective of the shape of the latter, which may be circular, elliptical, oblong, polygonal, in particular rectangular or square or oval. In the case of a rectangular cross section, the filamentary reinforcing element is in the form of a band.

The matrix is said to be a polymeric matrix because it is made from a polymeric composition, this polymeric composition being able to comprise one or more polymers, for example selected from thermoplastic polymers, thermosetting polymers, elastomers, thermoplastic elastomers, but also fillers and other components routinely used in used the field of compositions for tyres, in particular compositions for embedding reinforcing elements.

The tyre according to the invention has a substantially toroidal shape about an axis of revolution substantially coincident with the axis of rotation of the tyre. This axis of revolution defines three directions conventionally used by a person skilled in the art: an axial direction, a circumferential direction and a radial direction.

The expression “axial direction” should be understood to mean the direction substantially parallel to the axis of revolution of the tyre, i.e., the axis of rotation of the tyre.

The expression “circumferential direction” should be understood to mean the direction that is substantially perpendicular to both the axial direction and to a radius of the tyre (in other words, tangent to a circle centred on the axis of rotation of the tyre).

The expression “radial direction” should be understood to mean the direction along a radius of the tyre, i.e., any direction that intersects the axis of rotation of the tyre and is substantially perpendicular to that axis.

The expression “median plane of the tyre” (denoted M) should be understood to mean the plane perpendicular to the axis of rotation of the tyre which is situated axially midway between the two beads and passes through the axial middle of the crown reinforcement.

The expression “equatorial circumferential surface of the tyre” should be understood to mean the combination of the planes passing, in each meridian section plane, through the equator (denoted E) of the tyre and perpendicular to the median plane and to the radial direction. The equator of the tyre is, in a meridian section plane (plane perpendicular to the circumferential direction and parallel to the radial and axial directions) the axis parallel to the axis of rotation of the tyre and situated equidistantly between the radially outermost point of the tread that is intended to be in contact with the ground and the radially innermost point of the tyre that is intended to be in contact with a support, for example a rim, the distance between these two points being equal to H.

The expression “meridian plane” should be understood to mean a plane parallel to and containing the axis of rotation of the tyre and perpendicular to the circumferential direction.

The expressions “radially inner” and “radially outer” should be understood to mean closer to the axis of rotation of the tyre and further away from the axis of rotation of the tyre, respectively. The expressions “axially inner” and “axially outer” should be understood to mean closer to the median plane of the tyre and further away from the median plane of the tyre, respectively.

The term “bead” should be understood to mean the portion of the tyre that is intended to allow the tyre to be secured to a mounting support, for example a wheel comprising a rim. Thus, each bead is intended, in particular, to be in contact with a flange of the rim allowing it to be secured. Therefore, the radially outer end of the outer surface of the bead of the tyre is defined as the radially outermost point of the outer surface of the tyre in contact with a measuring rim for measuring the tyre according to the ETRTO Standards Manual 2021, when the tyre is inflated to its rated pressure on this measuring rim.

Any range of values denoted by the expression “between a and b” indicates the range of values extending from more than a to less than b (i.e., endpoints a and b excluded), whereas any range of values denoted by the expression “from a to b” means the range of values extending from a up to b (i.e., including the strict endpoints a and b).

The tyres are, in certain preferred embodiments of the invention, intended for a passenger vehicle as defined by the ETRTO Standards Manual 2021. Such a tyre has a cross section in a meridian section plane characterized by a section height H and nominal section width S as defined by the ETRTO Standards Manual 2021 such that, optionally, the ratio H/S, expressed as a percentage, is at most equal to 90, preferably at most equal to 50 and more preferably at most equal to 40 and is at least equal to 20, preferably at least equal to 25, and the nominal section width S is at least equal to 155 mm, preferably at least equal to 205 mm and more preferably at least equal to 225 mm and at most equal to 385 mm, preferably at most equal to 335 mm. Furthermore, the diameter at the flange D, defining the diameter of the tyre mounting rim, is at least equal to 12 inches, preferably at least equal to 16 inches and at most equal to 24 inches.

For any crown layer, a continuous surface referred to as the radially outer surface (SRE) of said layer is defined, passing through the radially outermost point of each reinforcing element and a continuous surface, referred to as the radially inner surface (SRI) of said layer, passing through the radially innermost point of each reinforcing element. The radial distances between a layer of the crown reinforcement comprising reinforcing elements and any other point are measured from one or other of these surfaces and in such a way as not to include the radial thickness of said layer. If the other measurement point is arranged radially to the outside of the layer of reinforcing elements, the radial distance is measured from the radially outer surface SRE at this point. If the other measurement point is arranged radially to the inside of the layer of reinforcing elements, the radial distance is measured from the radially inner surface SRI at this point.

In preferential embodiments, the maximum radial amplitude of the or each corrugation is greater than or equal to 1.0 mm, preferably to 1.5 mm. In other preferential embodiments, the maximum radial amplitude of the or each corrugation is less than or equal to 3.0 mm, preferably to 2.5 mm.

The expression “maximum radial amplitude” of a corrugation should be understood to mean the straight distance in the radial direction between the point of the radially outer surface SRE of the top of the corrugation and the point of the radially outer surface SRE of the radially innermost bottom of one of the first and second bottoms of said corrugation.

In preferential embodiments, over at least 10%, and preferably over at least 20% of the axial width of the corrugated crown layer separating each first and second bottom of the or each corrugation, the radial distance between the radially outer surface SRE and the point of the radially outer surface SRE of the radially innermost bottom of one of the first and second bottoms of the or each corrugation is greater than or equal to 1.0 mm, preferably to 1.5 mm. In other preferential embodiments, over at least 10%, and preferably over at least 20% of the axial width of the corrugated crown layer separating each first and second bottom of the or each corrugation, the radial distance between the radially outer surface SRE and the point of the radially outer surface SRE of the radially innermost bottom of one of the first and second bottoms of the or each corrugation is less than or equal to 3.0 mm, preferably to 2.5 mm.

In preferential embodiments, the corrugated crown layer is the radially outermost layer of the crown reinforcement. In certain embodiments of tyres for passenger vehicles, the radially outermost layer of the crown reinforcement is the hooping layer.

In advantageous embodiments, the or each corrugated crown layer comprises a plurality of corrugations.

Preferably, the or each corrugated crown layer extends axially from one side to the other of the median plane of the tyre.

In one optional embodiment, each sidewall comprises a sidewall insert arranged axially between the outer surface of said sidewall and the inner surface of said sidewall, each sidewall insert comprising at least one elastomeric composition referred to as a rigid elastomeric composition, the or each rigid elastomeric composition of each sidewall insert having a modulus at 10% extension greater than or equal to 6 MPa, the maximum thickness of the rigid elastomeric composition or the assembly of rigid elastomeric compositions of each sidewall insert being less than or equal to 5.0 mm.

Therefore, in a first variant, there may be two sidewall inserts arranged in the two sidewalls of the tyre, these two sidewall inserts having the same maximum thickness and the same rigid elastomeric composition(s).

In a second variant, there may be two sidewall inserts arranged in the two sidewalls of the tyre, these two sidewall inserts having different maximum thicknesses and/or one or more rigid elastomeric composition(s) having different moduli at 10% extension. In particular, if the tyre has a mounting direction indicating an outer side and an inner side when mounting it on a vehicle, preference is given to the scenario in which the insert of the sidewall intended to be on the outer side has a maximum thickness and/or one or more rigid elastomeric composition(s) having a modulus at 10% extension greater than those of the insert of the sidewall intended to be on the inner side.

In an optional embodiment, the tread comprising at least one rib and first and second cuts adjacent to the rib, the top of said corrugation of said corrugated crown layer is arranged in line with the rib and each first and second bottom of said corrugation of said corrugated crown layer is arranged respectively in line with each first and second cut adjacent to the rib.

The portion of the corrugated crown layer arranged in line with a rib or a cut is the axial portion of the corrugated crown layer delimited by axial ends defined by two circumferential planes perpendicular to the axis of rotation of the tyre and passing respectively through the axial ends of the rib or the cut. Therefore, a top of a corrugation of the corrugated crown layer is in line with the rib if this top lies axially between the two circumferential planes passing through the axial ends of the rib and described above. Similarly, a bottom of a corrugation of the corrugated crown layer is in line with a cut if this bottom lies axially between the two circumferential planes passing through the axial ends of the cut and described above.

The expression “cut adjacent to the rib” should be understood to mean that no other cut is arranged axially between the cut and the rib.

A cut denotes either a groove or a sipe, and forms a space opening onto the tread surface.

A sipe or a groove has, on the tread surface, two main characteristic dimensions: a width and a curvilinear length which are such that the curvilinear length is at least equal to twice the width. A sipe or a groove is therefore delimited by at least two main lateral faces determining its curvilinear length and connected by a bottom face, the two main lateral faces being separated from one another by a non-zero distance referred to as the width of the cut.

The width of a cut is, on a new tyre, the maximum distance between the two main lateral faces measured, when the cut is not chamfered, at a radial dimension coincident with the tread surface and, when the cut is chamfered, at the radially outermost radial dimension of the cut that is radially inside the chamfer. The width is measured substantially perpendicular to the main lateral faces.

The axial width of a cut is measured in the axial direction of the tyre, for example in a meridian section plane of the tyre.

A sipe is such that the distance between the main lateral faces is suitable for allowing the main lateral faces that delimit said sipe to come into at least partial contact in the contact area, in particular when the tyre is new and under normal running conditions, in particular including the fact that the tyre is under rated load and at rated pressure.

A groove is such that the distance between the main lateral faces is such that these main lateral faces cannot come into contact with one another under normal running conditions, in particular including the fact that the tyre is under rated load and at rated pressure.

A cut may be transverse or circumferential.

A transverse cut is such that the cut extends in an average direction forming an angle strictly greater than 30°, preferably greater than or equal to 45°, with the circumferential direction of the tyre. The average direction is the shortest curve joining the two ends of the cut and parallel to the tread surface. A transverse cut may be continuous, i.e., not interrupted by a tread pattern or another cut, such that the two main lateral faces determining its length are uninterrupted along the length of the transverse cut. A transverse cut may also be discontinuous, i.e., interrupted by one or more tread patterns and/or one or more cuts, such that the two main lateral faces determining its length are interrupted by one or more tread patterns and/or one or more cuts.

A circumferential cut is such that the cut in an average direction forming an angle less than or equal to 30°, preferably less than or equal to 10°, with the circumferential direction of the tyre. The average direction is the shortest curve joining the two ends of the cut and parallel to the tread surface. In the case of a continuous circumferential cut, the two ends coincide with each other and are joined by a curve that makes a full circle around the tyre. A circumferential cut may be continuous, i.e., not interrupted by a tread pattern or another cut, such that the two main lateral faces determining its length are uninterrupted over a full circle around the tyre. A circumferential cut may also be discontinuous, i.e., interrupted by one or more tread patterns and/or one or more cuts, such that the two main lateral faces determining its length are interrupted by one or more tread patterns and/or one or more cuts over a full circle around the tyre.

In the case of a circumferential cut situated outside the median plane of the tyre, the lateral faces are referred to as the axially inner face and axially outer face, the axially inner face being arranged, at a given azimuth, axially to the inside of the axially outer face in relation to the median plane.

Each circumferential cut comprises axially inner and outer axial ends. Irrespective of whether or not a circumferential cut has a chamfer, each axially inner and outer end is located respectively on each axially inner or outer edge.

In the case of a transverse cut, the lateral faces are referred to as the leading face and trailing face, the leading face being that whose edge, for a given circumferential line, enters the contact area before the edge of the trailing face.

In embodiments, the or each circumferential cut is chamfered. A chamfer of a circumferential cut may be a straight or rounded chamfer. A straight chamfer is formed by a planar face that is inclined with respect to the axially inner and outer face that it extends up to the axially inner or outer edge axially delimiting the circumferential cut. A rounded chamfer is formed by a curved face that merges tangentially into the axially inner or outer face that it extends. A chamfer of a circumferential cut is characterized by a height and a width that are respectively equal to the radial distance and to the axial distance between the point common to the axially inner or outer face extended by the chamfer and the axially inner or outer edge that axially delimits the circumferential cut.

In some embodiments, the or each transverse cut is chamfered. In other words, each transverse cut is radially delimited by leading and trailing faces that circumferentially delimit said transverse cut and are connected to one another by a bottom face that delimits said transverse cut radially towards the inside. A chamfer of a transverse cut may be a straight chamfer or rounded chamfer. A straight chamfer is formed by a planar face that is inclined with respect to the leading or trailing face that it extends as far as the leading or trailing edge circumferentially delimiting the transverse cut. A rounded chamfer is formed by a curved face that merges tangentially into the leading or trailing face that it extends. A chamfer of a transverse cut is characterized by a height and a width which are respectively equal to the radial distance and to the distance in a direction perpendicular to the leading or trailing faces between the point common to the leading or trailing face extended by the chamfer and the leading or trailing edge that circumferentially delimits the transverse cut.

On a new tyre, the depth of a cut is the maximum radial distance between the bottom of the cut and its projection onto the ground when the tyre is running. The maximum value of the depths of the cuts is referred to as the height of the tread pattern.

In embodiments in which each first and second adjacent circumferential cut is relatively wide, in particular in the case of tyres for passenger vehicles, each first and second adjacent circumferential cut has an axial width greater than or equal to 1.0 mm, preferably greater than or equal to 4.0 mm and more preferably ranging from 4.0 mm to 20.0 mm.

In embodiments in which each first and second adjacent circumferential cut is relatively deep, in particular in the case of tyres for passenger vehicles, each first and second adjacent circumferential cut has a depth greater than or equal to 50% of the height of the tread pattern Hs. Therefore, preferably, each first and second adjacent circumferential cut has a depth ranging from 4.0 mm to the height of the tread pattern.

In very advantageous embodiments, the tread comprising a plurality of ribs and a plurality of cuts, each rib of the plurality of ribs having adjacent first and second cuts of the plurality of cuts, the corrugated crown layer comprises, in the central part of the crown reinforcement, a plurality of corrugations, the top of each corrugation of said corrugated crown layer is arranged in line with one of the ribs and each first and second bottom of each corrugation of said corrugated crown layer is arranged respectively in line with each first and second cut adjacent to said rib.

In one advantageous embodiment, each first and second cut adjacent to the or each rib is a circumferential cut.

In advantageous variants in which the corrugated crown layer is the radially outermost layer of the crown reinforcement, the difference between:
the minimum radial distance between the or each top of the or each corrugation of the radially outermost layer of the crown reinforcement and the tread surface,
the depth of the or each circumferential cut in line with which each first and second bottom of said or each corrugation is arranged is less than or equal to 2 mm.

The minimum radial distance between the top of the or each corrugation and the tread surface is in this instance measured between the radially outer surface SRE of said corrugated crown layer and the tread surface.

In advantageous embodiments, the modulus at 10% extension of the or each rigid elastomeric composition is less than or equal to 20 MPa, preferably to 15 MPa and more preferably to 13 MPa. Although it improves the behaviour of the vehicle, excessive rigidity may nevertheless reduce the comfort of the vehicle. Furthermore, excessive rigidity may degrade flattening, reducing the surface area of the contact area. It is therefore preferable to use a sidewall insert that is not excessively rigid.

In advantageous embodiments, the maximum thickness of the rigid elastomeric composition or of the assembly of rigid elastomeric compositions ranges from 1.0 to 5.0 mm, preferably from 1.0 to 3.5 mm and more preferably from 1.0 to 2.5 mm and more preferably still from 1.2 to 1.7 mm. Although the rigidity is significantly greater than the rigidities of compositions conventionally used in tyre sidewalls, the greater the maximum thickness, the greater the improvement in the behaviour of the vehicle. However, beyond a maximum thickness that is too great, the comfort of the vehicle deteriorates, as does the flattening, which leads to a reduction in the surface area of the contact area.

In other advantageous embodiments, the or each sidewall having a minimum thickness at a point I, the thickness of the sidewall at a point of the inner surface being defined as the straight distance along the normal to the inner surface at said point of the inner surface between said point of the inner surface and a point of the outer surface of the tyre aligned along the normal with said point of the inner surface, the point of the inner surface at which the thickness of the rigid elastomeric composition or of the assembly of rigid elastomeric compositions is at a maximum is arranged radially between:
a radially outer straight line formed by the normal to the inner surface passing through a point of the inner surface arranged 10 mm radially to the outside of the point I,
a radially inner straight line formed by the normal to the inner surface passing through a point of the inner surface arranged 10 mm radially to the inside of the point I.

In other words, the thickness of the rigid elastomeric composition or of the assembly of rigid elastomeric compositions is at a maximum close to the zone in which the sidewall has the smallest thickness. Indeed, when the rigidity is the same, the sidewall bends the most where it has the smallest thickness. Therefore, it is advantageous, in order to effectively improve the behaviour of the vehicle, to make the sidewall more rigid in this zone that can potentially experience a high degree of bending.

Optionally, the thickness of the rigid elastomeric composition or of the assembly of rigid elastomeric compositions is at a maximum radially to the outside of the equator of the tyre.

In advantageous embodiments, the radially outer end of the sidewall insert is arranged radially to the outside of the equator of the tyre.

Advantageously, and optionally, the radially outer end of the sidewall insert is arranged radially and axially to the inside of a straight line normal to the inner surface and passing through the axially outer end of the axially widest crown layer of the crown reinforcement.

Indeed, by extending beyond the axially outer end of the axially widest crown layer, the sidewall insert would needlessly increase the weight and rolling resistance of the tyre.

In embodiments, the radially outer end is the radially outer end of the rigid elastomeric composition or the radially outermost end of the radially outer ends of the rigid elastomeric compositions of the assembly. In other embodiments, the radially outer end is the radially outermost end of the radially outer ends of the rigid or flexible elastomeric compositions of the insert.

In other advantageous embodiments, the radially inner end of the sidewall insert is arranged radially to the inside of the equator of the tyre.

Advantageously, and optionally, the radially inner end of the sidewall insert is arranged radially and axially to the outside of a straight line normal to the inner surface and passing through the radially outer end of the outer surface of the bead of the tyre.

Indeed, there is no need for the sidewall insert to extend too far radially inwards, in particular into the bead, because, as indicated in the preamble, this zone of the tyre is already sufficiently rigid. It would needlessly make the tyre heavier.

In embodiments, the radially inner end is the radially inner end of the rigid elastomeric composition or the radially innermost end of the radially inner ends of the rigid elastomeric compositions de the assemblage. In other embodiments, the radially inner end is the radially innermost end of the radially inner ends of the rigid or flexible elastomeric compositions of the insert.

In an optional but advantageous manner, the or each sidewall insert has a generally crescent-shaped cross section. Therefore, the width of the cross section of the sidewall insert is at a minimum at its radially inner and outer ends and is at a maximum between them.

Optionally, the tyre comprises a carcass reinforcement comprising at least one carcass layer anchored in the or each bead and extending radially in the or each sidewall and axially in the crown block radially to the inside of the crown reinforcement.

Optionally, the or each carcass layer is delimited axially by two axial ends and comprises carcass reinforcing elements extending axially from one axial end to the other of said carcass layer in a main direction that optionally and preferably forms, with the circumferential direction of tyre, an angle, expressed as an absolute value, greater than or equal to 60°, preferably ranging from 80° to 90°.

In certain embodiments, the tyre comprises an airtight inner layer carrying the inner surface of the tyre, and the sidewall insert is arranged axially between the airtight inner layer and the axially innermost carcass layer.

In other embodiments, it may be envisaged that the sidewall insert is arranged axially between the axially outermost carcass layer and the outer surface of the tyre.

In certain variants, the carcass reinforcement comprises a single carcass layer anchored in the or each bead and extending radially in each sidewall and axially in the crown block radially to the inside of the crown reinforcement. In these variants, the invention makes it possible, in particular, to avoid adding a second carcass layer or indeed using reinforced carcass reinforcing elements to improve the behaviour of the vehicle. The expression “single carcass layer anchored in the or each bead” should be understood to mean that the carcass reinforcement is, with the exception of the carcass layer, not provided with any layer reinforced with reinforcing elements and anchored in the or each bead. The reinforcing elements of such reinforced layers excluded from the carcass reinforcement of the tyre comprise metal reinforcing elements and textile reinforcing elements. Very preferably, the carcass reinforcement is made up of the single carcass layer. Even more preferably, the tyre has no sidewall reinforcing layer extending at least radially in each sidewall and having:
a radially inner end arranged radially to the inside of the equator of the tyre
a radially outer end arranged radially to the outside of the equator of the tyre.

The excluded sidewall reinforcing layers are therefore discontinuous under the crown of the tyre. An excluded sidewall reinforcing layer is not anchored in a bead of the tyre. Therefore, the radially inner end of the excluded sidewall reinforcing layer is arranged radially to the outside of the bead.

In other variants, the carcass reinforcement comprises first and second carcass layers anchored in the or each bead and extending radially in each sidewall and axially in the crown block radially to the inside of the crown reinforcement, the sidewall insert being arranged axially to the inside of the first carcass layer. In these other variants, the invention makes it possible, in particular, to avoid the use of a sidewall reinforcing layer or the use of reinforced carcass reinforcing elements to improve the behaviour of the vehicle. As described above, it may be envisaged that the sidewall insert is arranged axially to the inside of the axially innermost carcass layer. It may also be envisaged that the sidewall insert is arranged axially between the first carcass layer and the second carcass layer.

In advantageous embodiments, the crown reinforcement comprises a working reinforcement comprising at least one working layer and one hoop reinforcement comprising at least one hooping layer, the hoop reinforcement being arranged radially to the outside of the working reinforcement, the crown block preferably not being provided with an annular reinforcing structure.

In advantageous embodiments, the crown reinforcement comprises a working reinforcement comprising at least one working layer and one hoop reinforcement comprising at least one hooping layer, the hoop reinforcement being arranged radially to the outside of the working reinforcement, the or each hooping layer comprising, in the central part of the crown reinforcement, at least one corrugation.

Optionally, the or each hooping layer is delimited axially by two axial ends. The or each hooping layer comprises one or more hooping reinforcing elements wound circumferentially in a helical manner in such a way as to extend axially in a main direction from one axial end to the other of the hooping layer. Optionally, and preferably, the main direction forms, with the circumferential direction of the tyre, an angle with an absolute value less than or equal to 10°, preferably less than or equal to 7° and more preferably less than or equal to 5°.

Optionally, the or each working layer is delimited axially by two axial ends. The or each working layer comprises working reinforcing elements that extend axially from one axial end to the other, substantially parallel to each other in a main direction which optionally and preferably forms, with the circumferential direction of the tyre, an angle with an absolute value that is strictly greater than 10°, preferably ranging from 15° to 50° and more preferably from 25° to 45°.

In even more advantageous embodiments, the or each working layer comprises at least one corrugation.

Preferably, the or each hooping and working reinforcing element is a filamentary reinforcing element.

Preferably, when the tyre is inflated to its rated pressure, the inner surface does not have an inflection point arranged in line with the crown reinforcement. The part of the inner surface arranged in line with the crown reinforcement is the part of the inner surface that is arranged axially between the axial limits of the axially widest crown layer projected radially onto the inner surface.

Preferably, in each meridian plane, the or each central rib has a substantially flat tread surface that is intended to come into contact with the ground. The expression “substantially flat” should be understood to mean that the radial distance between the radially outermost point(s) of the tread surface of said central rib and the radially innermost point(s) of the tread surface is strictly less than 0.2 mm, preferably less than or equal to 0.1 mm, and preferably substantially zero. A central rib is a rib arranged axially between two adjacent circumferential cuts.

The invention will be more clearly understood upon reading the description below, which is provided purely as a non-limiting example, with reference to the drawings in which:

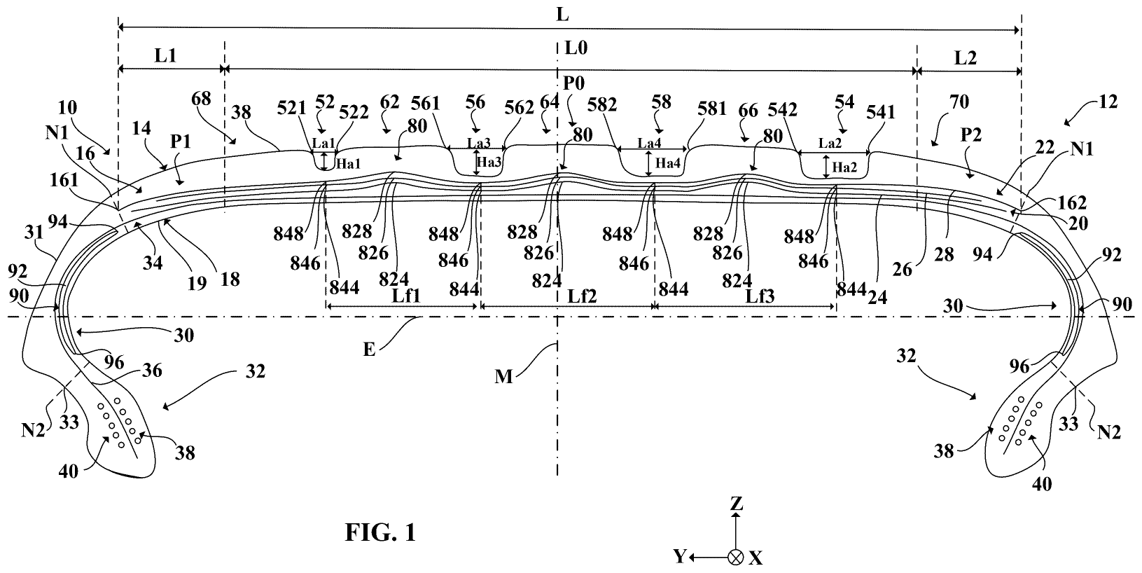

FIG. 1 is a view, in a meridian section plane parallel to the axis of rotation of the tyre, of a tyre according to a first embodiment of the invention,

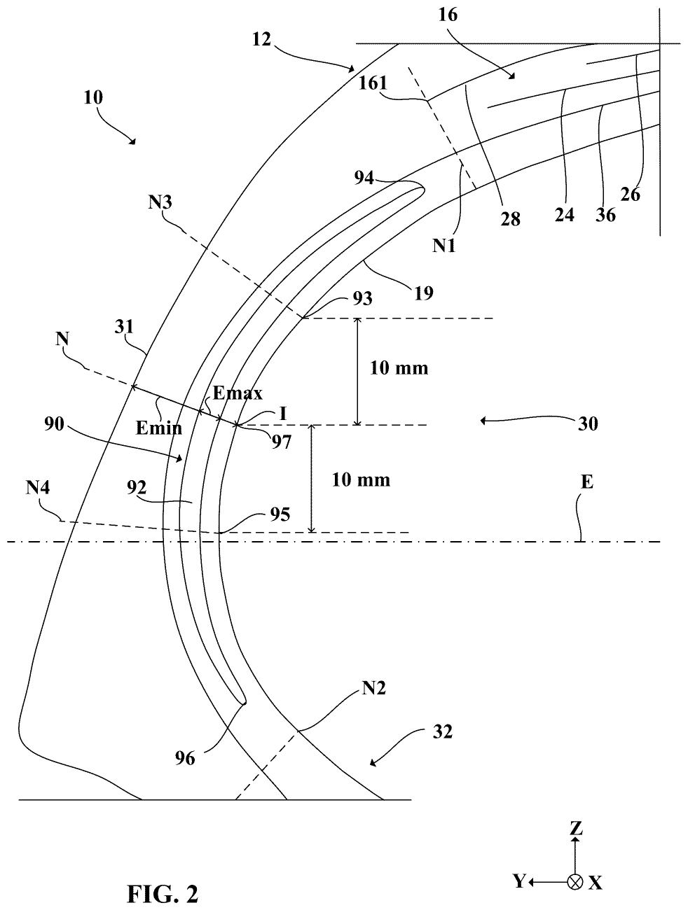

FIG. 2 is a detail view of one of the sidewalls of the tyre of FIG. 1,

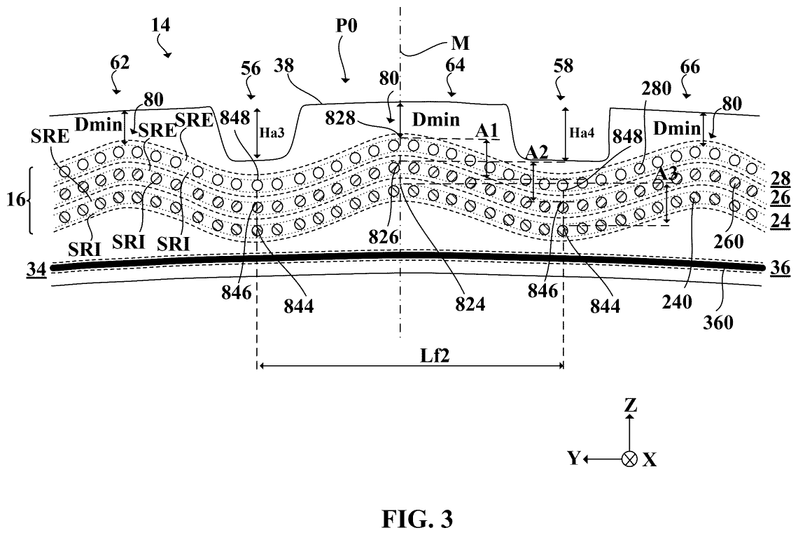

FIG. 3 is a detail view of the crown block of the tyre of FIG. 1,

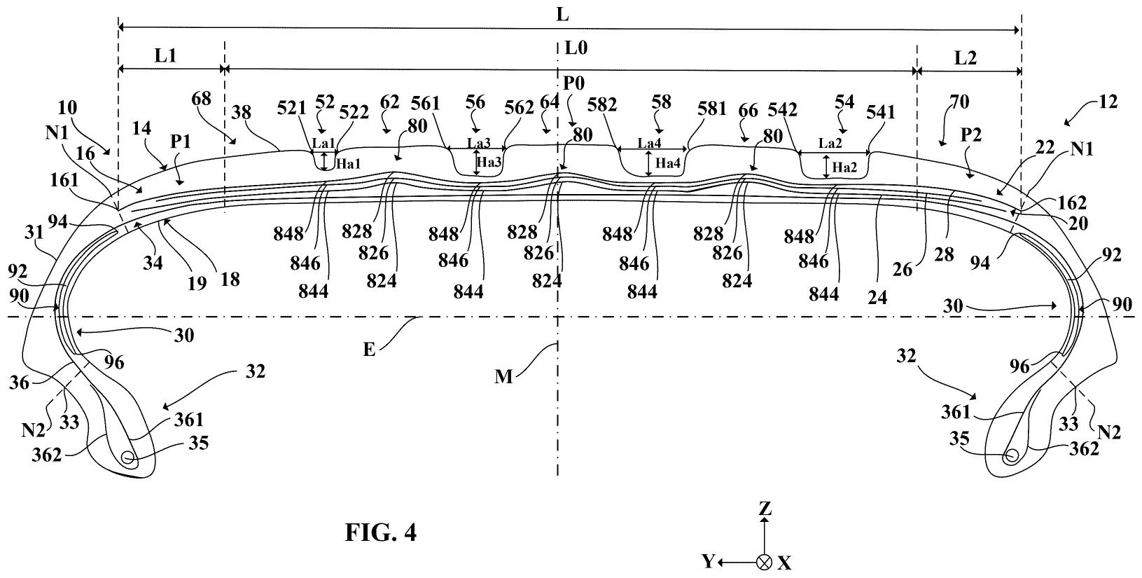

FIG. 4 is a view similar to that of FIG. 1 of a tyre according to a second embodiment of the invention, and

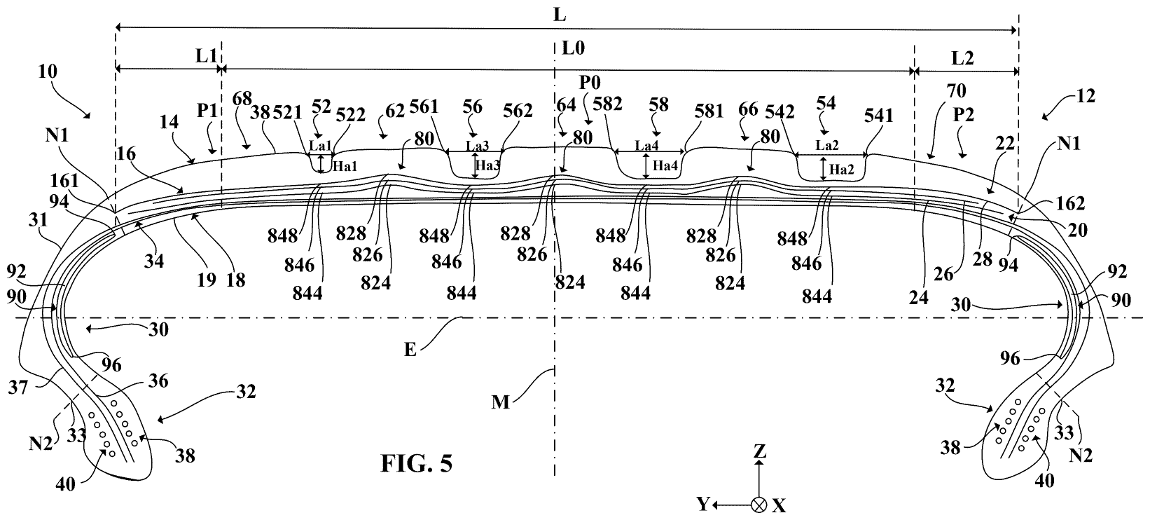

FIG. 5 is a view similar to that of FIG. 1 of a tyre according to a third embodiment of the invention.

A frame of reference X, Y, Z corresponding respectively to the usual axial (Y), radial (Z) and circumferential (X) directions of a tyre is shown in the figures relating to the tyre.

FIG. 1 shows a tyre according to the invention, denoted by the general reference number 10. The tyre 10 has a substantially toroidal shape about an axis of revolution substantially parallel to the axial direction Y. The tyre 10 is intended for a passenger vehicle and has dimensions 245/35 R20. The tyre 10 is not suitable for running flat. In the various figures, the tyre 10 is shown as new, i.e., when it has not yet been run.

The tyre 10 comprises a crown block 12 comprising a tread 14 intended to come into contact with the ground when it is running and a crown reinforcement 16 extending in the crown block 12 in the circumferential direction X. The tyre 10 also comprises an airtight inner layer 18 that is airtight to an inflation gas and is intended to delimit an internal cavity with a mounting support of the tyre 10, once the tyre 10 has been mounted on the mounting support, for example a rim, this cavity being intended to be pressurized with the inflation gas. The airtight inner layer 18 bears an inner surface 19 of the tyre 10. The tyre 10 also has an outer surface 31.

The crown reinforcement 16 comprises a working reinforcement 20 and a hoop reinforcement 22, each of these reinforcements 20, 22 comprising at least one crown layer. The working reinforcement 16 comprises at least one working layer and, in this instance, comprises two working layers comprising a radially inner working layer 24 arranged radially to the inside of a radially outer working layer 26.

The hoop reinforcement 22 comprises at least one hooping layer and in this instance comprises one hooping layer 28.

The crown reinforcement 16 is arranged radially to the inside of the tread 14. In this instance, the hoop reinforcement 22, in this case the hooping layer 28, is arranged radially to the outside of the working reinforcement 20 and is therefore interposed radially between the working reinforcement 20 and the tread 14.

The tyre 10 comprises two sidewalls 30 extending the crown block 12 radially towards the inside. The tyre 10 further comprises two beads 32 radially to the inside of the sidewalls 30. Each sidewall 30 connects each bead 32 to the crown block 12. Each sidewall 30 bears part of the outer surface 31 of said sidewall 30.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown block 12, radially to the inside of the crown reinforcement 16.

In order to anchor the carcass layer 36, the tyre 10 comprises an axially inner circumferential reinforcing element 38 arranged axially to the inside of the carcass layer 36 and an axially outer circumferential reinforcing element 40 arranged axially to the outside of the carcass layer 36. In this case, each reinforcing element 38, 40 comprises a continuous filamentary reinforcing element wound through several circumferential turns, for example as described in WO2021/123522.

The crown reinforcement 16 comprises two axial ends 161, 162 which are in this case coincident with the ends of the axially widest layer of the crown reinforcement 16. The crown reinforcement 16 comprises a central part P0 with an axial width L0 equal to 80% of the axial width L of the crown reinforcement 16, in this case the axial width of the hooping layer 28, and axially centred on the median plane M. The crown reinforcement 16 also comprises lateral parts P1, P2 arranged axially to either side of the central part P0 and each having an axial width L1=L2 equal to 10% of the axial width L of the crown reinforcement 16.

When the tyre is inflated to its rated pressure, the inner surface 19 does not have an inflection point arranged in line with the crown reinforcement 16, i.e., the inner surface 19 does not have an inflection point between the axial ends 161, 162.

Each working layer 24, 26, hooping layer 28 and carcass layer 36 comprises a polymeric matrix, in this instance an elastomeric matrix, in which one or more reinforcing elements of the corresponding layer are embedded, in this case filamentary reinforcing elements that will be described, in particular, in reference to FIGS. 1 and 3.

The hoop reinforcement 22, in this instance the hooping layer 28, is delimited axially by two axial ends 161, 162. The hoop reinforcement 22 comprises one or more hooping filamentary reinforcing elements 280 wound circumferentially in a helical manner in such a way as to extend axially in a main direction DO from one axial end to the other of the hooping layer 28. The main direction DO forms, with the circumferential direction X of the tyre 10, an angle AF with an absolute value less than or equal to 10°, preferably less than or equal to 7° and more preferably less than or equal to 5°. In this case, AF=−5°.

The radially inner working layer 24 is delimited axially by two axial ends. The radially inner working layer 24 comprises filamentary working reinforcing elements 240 extending axially from one axial end to the other, substantially parallel to each other in a main direction D1. Similarly, the radially outer working layer 26 is delimited axially by two axial ends. The radially outer working layer 26 comprises filamentary working reinforcing elements 260 extending axially from one axial end to the other, substantially parallel to each other in a main direction D2. Each main direction D1, D2 forms, with the circumferential direction X of the tyre 10, an angle AT1, AT2, respectively, that have opposite orientations. Each main direction D1, D2 forms an angle AT1, AT2, respectively, the absolute value of which is strictly greater than 10°, preferably ranging from 15° to 50° and more preferentially ranging from 25° to 45°, with the circumferential direction X of the tyre 10. In this case, AT1=−33° and AT2=+33°.

The carcass layer 36 is delimited axially by two axial ends. The carcass layer 36 comprises filamentary carcass reinforcing elements 360 extending axially from one axial end to the other of the carcass layer 36 in a main direction D3 forming, with the circumferential direction X of the tyre 10, an angle AC, the absolute value of which is greater than or equal to 60°, preferably ranging from 80° to 90°, and in this case AC=+90°.

Each filamentary hooping reinforcing element 280, working reinforcing element 240, 260 and carcass reinforcing element 360 is, for example, identical to those described in application WO2021/123522.

In reference to FIGS. 1 and 3, the tread 14 comprises a tread surface 38 by means of which the tread 14 comes into contact with the ground.

The tread 14 comprises several circumferential cuts, in this case several circumferential grooves, comprising first, second, third and fourth circumferential cuts respectively denoted by reference numbers 52, 54, 56, 58. Each circumferential cut 52 to 58 is axially delimited by an axially outer end respectively denoted by reference number 521, 541, 561, 581 and by an axially inner end respectively denoted by reference number 522, 542, 562, 582. Each circumferential cut 52 to 58 has a depth respectively denoted by reference number Ha1, Ha2, Ha3, Ha4 and ranging from 4.0 mm to the tread-pattern height Hs. Each depth Ha, Ha, Ha3, Ha4 is greater than or equal to 50% of the tread-pattern height Hs. In this instance, Hs=Ha2=Ha3=Ha4=7.5 mm and Ha1=5.0 mm. Each circumferential cut 52 to 58 has an axial width respectively denoted by reference number La1, La2, La3, La4 and greater than or equal to 1.0 mm, preferably greater than or equal to 4.0 mm and more preferably ranging from 4.0 mm to 20.0 mm. In this instance, La1=7.4 mm and La3=14.4 mm, La2=La4=18.0 mm.

The tread 14 also comprises several central ribs and, in this instance, first, second and third central ribs respectively denoted by reference numbers 62, 64, 66. Each central rib 62, 64, 66 is arranged axially between two of the adjacent circumferential cuts 52 to 58 and is delimited axially by two adjacent circumferential cuts 52 to 58. Each central rib 62, 64, 66 is axially delimited by an axially inner end and by an axially outer end, each axially inner and outer end being an axially inner or outer end of the circumferential cuts 52 to 58. The axially inner and outer ends of each central rib 62, 64, 66 are adjacent to each other. In this specific case, the central rib 62 is axially delimited by the axially inner end 522 of the circumferential cut 52 and by the axially outer end 561 of the circumferential cut 56. The central rib 64 is axially delimited by the axially inner end 562 of the circumferential cut 56 and by the axially inner end 582 of the circumferential cut 58. The central rib 66 is axially delimited by the axially outer end 581 of the circumferential cut 58 and by the axially inner end 542 of the circumferential cut 54. Therefore, the circumferential cuts 52, 56 are adjacent to the ribs 62, the circumferential cuts 56, 58 are adjacent to the rib 64 and the circumferential cuts 58, 54 are adjacent to the rib 66. Each central rib 62, 64, 66 has a substantially flat tread surface intended to come into contact with the ground.

The tread 14 also comprises first and second lateral ribs 68, 70.

Although it is not shown in FIGS. 1 and 3, each central rib 62, 64, 66 and each lateral rib 68, 70 comprises transverse cuts formed in each central rib 62, 64, 66 and each lateral rib 68, 70.

FIG. 3 depicts:
in dotted lines, the radially outer surfaces SRE passing through the radially outermost points of the radially outermost reinforcing elements 240, 260 and 280 of each crown layer 24, 26, 28,
in dotted lines, the radially inner surfaces SRI passing through the radially innermost points of the radially innermost reinforcing elements 240, 260 and 280 of each crown layer 24, 26, 28,
in dashed lines, the interfaces of the polymeric matrices in which the reinforcing elements of each crown layer 24, 26, 28 are embedded.

In reference to FIGS. 1 and 3, each crown layer, in this instance each working layer 24, 26 and the hooping layer 28, comprises, in the central part P0 of the crown reinforcement 16, a plurality of corrugations 80, and is therefore said to be a corrugated crown layer. Each corrugation 80 of each corrugated crown layer 24, 26, 28 comprises a top 824, 826, 828 of each corrugated crown layer 24, 26, 28 respectively, first bottoms 844, 846, 848 of each corrugated crown layer 24, 26, 28 respectively and second bottoms 844, 846, 848 of each corrugated crown layer 24, 26, 28 respectively. The tops and the bottoms are arranged in such a way that each top 824, 826, 828 is arranged respectively axially between the first and second bottoms 844, the first and second bottoms 846 and the first and second bottoms 848. The tops and the bottoms are arranged in such a way that each top 824, 826, 828 is arranged radially to the outside of the first and second bottoms 844, the first and second bottoms 846 and the first and second bottoms 848 respectively. In FIG. 3, if radial distances need to be measured, the tops 824, 826, 828 and the bottoms 844, 846, 848 are used on the radially outer surface SRE of each layer in question.

Each top 824, 826, 828 of each corrugation 80 of each corrugated crown layer 24, 26, 28 is arranged in line with one of the central ribs 62, 64, 66. Each first and second bottom 844, 846, 848 of each corrugation 80 of each corrugated crown layer 24, 26, 28 is arranged respectively in line with each first and second cut 52 and 56, 56 and 58, 58 and 54 adjacent to each rib 62, 64, 66.

Each maximum radial amplitude A1, A2, A3 of each corrugation 80 of each corrugated crown layer 24, 26, 28 is greater than or equal to 1.0 mm, preferably to 1.5 mm, and less than or equal to 3.0 mm, preferably to 2.5 mm. In this particular case, each maximum radial amplitude A1, A2, A3 is substantially equal to 2.0 mm.

Over at least 10%, and preferably over at least 20% of the axial width Lf1, Lf2, Lf3 of each corrugated crown layer 24, 26, 28 separating each first and second bottom 844, 846, 848 of each corrugation 80, the radial distance between the radially outer surface SRE and the radially innermost point of the radially outer surface SRE of the bottom 844, 846, 848 of one of the first and second bottoms 844, 846, 848 of each corrugation 80 is greater than or equal to 1.0 mm, preferably to 1.5 mm, and less than or equal to 3.0 mm, preferably to 2.5 mm. In this particular case, the radial distance is greater than or equal to 1.5 mm and less than or equal to 2.5 mm over approximately 30% of each axial width Lf1, Lf2, Lf3.

Furthermore, the difference between the minimum radial distance Dmin between each top 828 of each corrugation 80 of the hooping layer 28 and the tread surface 38, and the depth Ha2, Ha3, Ha4 of each circumferential cut 54, 56, 58 in line with which each first and second bottom 848 of each corrugation 80 of the hooping layer 28 is arranged, is less than or equal to 2 mm.

The tyre comprises two sidewall inserts 90. Each sidewall insert 90 is arranged axially between the outer surface 31 of one of the sidewalls 30 and the inner surface 19 of said sidewall 30. More precisely, each sidewall insert 90 is arranged axially between the airtight inner layer 18 and the axially innermost carcass layer, in this case the single carcass layer 36. Each sidewall insert 90 has a generally crescent-shaped cross section.

Each sidewall insert 90 comprises at least one elastomeric composition referred to as a rigid elastomeric composition. In this case, each sidewall insert 90 comprises a rigid elastomeric composition 92 and is in this particular instance constituted by a rigid elastomeric composition 92. The rigid elastomeric composition 92 of each sidewall insert 90 has a modulus MA10 at 10% extension greater than or equal to 6 MPa and less than or equal to 20 MPa, preferably to 15 MPa and more preferably to 13 MPa. In this case, MA10=8 MPa. In order to formulate this rigid elastomeric composition, the teaching of WO2014184158 or WO2018111773 can be used, for example.

Each sidewall insert 90 comprises a radially outer end 94 and a radially inner end 96. Each radially outer end 94 is arranged radially to the outside of the equator E and radially and axially to the inside of a straight line N1 normal to the inner surface 19 and passing through each axially outer end 161, 162 of the axially widest crown layer of the crown reinforcement 16, in this instance the hooping layer 28. Each radially inner end 96 is arranged radially to the inside of the equator E and radially and axially to the outside of a straight line N2 normal to the inner surface 19 and passing through the radially outer end 33 of the outer surface 31 of each bead 32.

In reference to FIG. 2, the thickness of the rigid elastomeric composition 92 and therefore, in this case, of the sidewall insert 90 is at a maximum radially to the outside of the equator E. In this particular instance, the thickness of the rigid elastomeric composition 92 and therefore, in this case, of the sidewall insert 90 is at a maximum between a radially outer straight line formed by the normal N3 to the inner surface 19 passing through a point 93 of the inner surface 19 arranged 10 mm radially to the outside of a point I, and a radially inner straight line formed by the normal N4 to the inner surface 19 passing through a point 95 of the inner surface 19 arranged 10 mm radially to the inside of this same point I. The point I is the point of each sidewall 30 having a minimum thickness at this point I, the thickness of the sidewall 30 at a point of the inner surface 19 being defined as the straight distance along the normal N to the inner surface 19 at this point of the inner surface 19 between this point of the inner surface 19 and a point of the outer surface of the tyre aligned along the normal N with this point of the inner surface 19. In this case, the point 97 is the point of the inner surface 19 at which the thickness of the rigid elastomeric composition 92 and therefore, in this case, of the sidewall insert 90, is at a maximum, this point 97 of the inner surface 19 being arranged radially between the radially outer straight line N3 and the radially inner straight line N4. In this case, the point 97 and the point I are substantially coincident, meaning that the maximum thickness Emax is obtained substantially where the thickness of each sidewall 30 is at a minimum.

The maximum thickness Emax of the rigid elastomeric composition 92 and therefore, in this case, of the sidewall insert 90, is less than or equal to 5.0 mm, preferably ranges from 1.0 to 5.0 mm, more preferably from 1.0 to 3.5 mm and more preferably still from 1.0 to 2.5 mm, and very preferably from 1.2 to 1.7 mm. In this case, Emax=1.5 mm and the minimum thickness Emin of each sidewall 30 is such that Emin=5.1 mm.

Tyres according to second and third embodiments of the invention respectively will now be described in reference to FIGS. 4 and 5, in which elements similar to those shown in the previous figures are denoted by identical reference numbers.

Unlike the tyre according to the first embodiment, the tyre 10 according to the second embodiment in FIG. 4 is such that, in order to anchor the carcass layer 36, the tyre 10 comprises a circumferential reinforcing element, in this particular case a bead wire 35 around which the carcass layer 36 is wound in such a way as to form an axially inner portion 361 and an axially outer portion 362 arranged axially to the outside of the axially inner portion 361.

Unlike the tyres according to the first and second embodiments, the carcass reinforcement 34 of the tyre 10 according to the third embodiment comprises first and second carcass layers 36, 37 anchored in each bead 32 and extending radially in each sidewall 30 and axially in the crown block 12 radially to the inside of the crown reinforcement 16. The second carcass layer 37 is arranged axially and radially to the outside of the first carcass layer 36. The sidewall insert 90 is arranged axially to the inside of the first carcass layer 36.

### Comparative Tests

The tyre 10 according to the first embodiment and according to the invention was compared with a reference tyre T1 not according to the invention comprising corrugated crown layers and not provided with a sidewall insert and a control tyre T2 not according to the invention comprising corrugated crown layers and a carcass reinforcement comprising first and second carcass layers and not provided with a sidewall insert.

The tyres 10, T1 and T2 were tested in order to measure their rolling resistance, weight, lateral rigidity, cornering rigidity and behaviour during a subjective test referred to as a soft test used to evaluate the behaviour of a vehicle equipped with the tyres under normal usage conditions and their subjective behaviour during a subjective test referred to as a stress test used to evaluate the behaviour of a vehicle equipped with the tyres under sports conditions representative, in particular, of use on a circuit.

The subjective tests were carried out on a circuit by fitting Ferrari 488 GTB and Porsche Panamera vehicles with the different tyres 10, T1, T2 in their corresponding dimensions.

The results of these tests are given in table 1 below in which “Ref” indicated a reference value for the corresponding performance.

TABLE 1

| | T1 | T2 | 10 |
|---|---|---|---|
| Rolling resistance (kg/T) | Ref. | +0.50 kg/T | +0.15 kg/T |
| Weight (g) | Ref. | +200 g | +180 g |
| Manufacturing cost | Ref. | +++ | + |
| Lateral rigidity | Ref. | +12% | +3% |
| Cornering rigidity | Ref. | +5% | +2% |
| Soft test | Ref. | = | + |
| Stress test | Ref. | ++ | + |

Table 1 indicates that the tyre 10 helps achieve better vehicle behaviour than the reference tyre T1. Despite lower dynamic performance than the control tyre T2, in particular due to lower lateral rigidity and cornering rigidity than the control tyre T2, the tyre 10 according to the invention nevertheless offers a significantly better compromise than the control tyre T2 between behaviour, weight and, above all, manufacturing cost and rolling resistance.

With respect to the manufacturing cost, the indication “+++” relating to control tyre T2 indicates a much higher cost than the manufacturing cost of the reference tyre T1 and the tyre of the invention 10.

With respect to the soft test, the indication “+” relating to the tyre 10 indicates reduced under-steer and improved high-speed stability compared to the reference tyre T1 and the control tyre T2.

With respect to the stress test, the indication “++” relating to the control tyre T2 indicates improved grip stability, improved cornering rigidity and improved over-steer behaviour compared to the reference tyre T1. The indication “+” relating to the tyre 10 indicates improved grip stability, improved cornering rigidity and slightly improved over-steer behaviour compared to the reference tyre T1.

Therefore, the invention makes it possible to obtain a tyre that performs beyond the level expected with a corrugated crown layer.

The invention is not limited to the embodiments described above.

1.-15. (canceled)

16. A tire not suitable for running flat comprising a crown block, two beads, two sidewalls connecting each bead to the crown block,
the crown block comprising a tread and a crown reinforcement arranged radially to an inside of the tread,
the crown reinforcement comprising a central part with an axial width equal to 80% of an axial width of the crown reinforcement and axially centered on a median plane of the tire,
the crown reinforcement comprising at least one corrugated crown layer comprising reinforcing elements embedded in a polymeric matrix, the at least one corrugated crown layer comprising, in the central part of the crown reinforcement, at least one corrugation, the or each corrugation of the at least one corrugated crown layer comprising a top of the at least one corrugated crown layer and first and second bottoms of the at least one corrugated crown layer adjacent to the top arranged in such a way that:
the top is arranged axially between the first and second bottoms, and
the top is arranged radially to an outside of each first and second bottom,
wherein the tire comprises a sidewall insert arranged axially between an outer surface of at least one of the sidewalls and an inner surface of the sidewall, and
wherein the sidewall insert comprises at least one rigid elastomeric composition, the at least one rigid elastomeric composition of the sidewall insert having a modulus at 10% extension greater than or equal to 6 MPa, and a maximum thickness of the at least one rigid elastomeric composition being less than or equal to 5.0 mm.

17. The tire according to claim 16, wherein the tread comprises at least one rib and first and second cuts adjacent to the at least one rib,
the top of the corrugation of the at least one corrugated crown layer is arranged in line with the at least one rib, and
each first and second bottom of the corrugation of the at least one corrugated crown layer is arranged respectively in line with each first and second cut adjacent to the at least one rib.

18. The tire according to claim 16, wherein the tread comprises a plurality of ribs and a plurality of cuts, each rib of the plurality of ribs having first and second cuts adjacent to the plurality of ribs,
the at least one corrugated crown layer comprises, in the central part of the crown reinforcement, a plurality of corrugations,
the top of each corrugation of the at least one corrugated crown layer is arranged in line with one of the ribs, and
each first and second bottom of each corrugation of the at least one corrugated crown layer is arranged respectively in line with each first and second cut adjacent to the rib.

19. The tire according to claim 16, wherein the modulus at 10% extension of the at least one rigid elastomeric composition is less than or equal to 20 MPa.

20. The tire according to claim 16, wherein the maximum thickness of the at least one rigid elastomeric composition ranges from 1.0 to 5.0 mm.

21. The tire according to claim 16, wherein the or each sidewall has a minimum thickness at a point I,
a thickness of the sidewall at a point of the inner surface is defined as a straight distance along a normal to the inner surface at the point of the inner surface between the point of the inner surface and a point of the outer surface of the tire aligned along the normal with the point of the inner surface,
a point of the inner surface at which a thickness of the at least one rigid elastomeric composition is at a maximum is arranged radially between:
a radially outer straight line formed by the normal to the inner surface passing through a point of the inner surface arranged 10 mm radially to the outside of the point I, and
a radially inner straight line formed by the normal to the inner surface passing through a point of the inner surface arranged 10 mm radially to the inside of the point I.

22. The tire according to claim 16, wherein a thickness of the at least one rigid elastomeric composition is at a maximum radially to an outside of an equator of the tire.

23. The tire according to claim 16, wherein a radially outer end of the sidewall insert is arranged radially to an outside of an equator of the tire.

24. The tire according to claim 16, wherein a radially inner end of the sidewall insert is arranged radially to an inside of an equator of the tire.

25. The tire according to claim 16, further comprising a carcass reinforcement comprising at least one carcass layer anchored in the or each bead and extending radially in the or each sidewall and axially in the crown block radially to the inside of the crown reinforcement.

26. The tire according to claim 25, further comprising an airtight inner layer carrying an inner surface of the tire, the sidewall insert being arranged axially between the airtight inner layer and an axially innermost carcass layer.

27. The tire according to claim 25, wherein the carcass reinforcement comprises a single carcass layer anchored in the or each bead and extending radially in each sidewall and axially in the crown block radially to an inside of the crown reinforcement.

28. The tire according to claim 25, wherein the carcass reinforcement comprises first and second carcass layers anchored in the or each bead and extending radially in each sidewall and axially in the crown block radially to the inside of the crown reinforcement, the sidewall insert being arranged axially to an inside of the first carcass layer.

29. The tire according to claim 16, wherein the crown reinforcement comprises a working reinforcement comprising at least one working layer and one hoop reinforcement comprising at least one hooping layer, the at least one hoop reinforcement being arranged radially to an outside of the working reinforcement, the at least one hooping layer comprising, in the central part of the crown reinforcement, at least one corrugation.

30. The tire according to claim 29, wherein the at least one working layer comprises at least one corrugation.
